(19) United States
(12) Patent Application Publication
(10) Pub. No.: US 2015/0121262 A1
(43) Pub. Date: Apr. 30, 2015

(54) MOBILE DEVICE AND METHOD FOR MANAGING DIAL INTERFACE OF MOBILE DEVICE

(71) Applicants: Chiun Mai Communication Systems, Inc., New Taipei (TW); SHENZHEN FUTAIHONG PRECISION INDUSTRY CO., LTD., Shenzhen (CN)

(72) Inventor: LIN-LIN YAO, Shenzhen (CN)

(73) Assignees: CHIUN MAI COMMUNICATION SYSTEMS, INC., New Taipei (TW); SHENZHEN FUTAIHONG PRECISION INDUSTRY CO., LTD., Shenzhen (CN)

(21) Appl. No.: 14/135,605

(22) Filed: Dec. 20, 2013

(30) Foreign Application Priority Data
Oct. 31, 2013 (CN) 2013105265983

(51) Int. Cl. G06F 3/0488; G06F 3/0484; H04M 1/02

(52) U.S. Cl. CPC G06F 3/04886; H04M 1/0281; G06F 3/0484
USPC 715/765

(57) ABSTRACT

In a method for managing a dial interface of a mobile device, a touch operation of a finger on a dial interface of the mobile device is detected. The mobile device is controlled to operate in a right-hand mode if the touch operation of the finger is detected moving downward on a right side of the dial interface. And the mobile device is controlled to operate in a left-hand mode if the touch operation of the finger is detected moving downward on a left side of the dial interface.

### BACKGROUND

1. Technical Field

The embodiments of the present disclosure relate to a mobile device and a method for managing a dial interface of the mobile device.

2. Description of Related Art

Screens of mobile devices, such as mobile phones, are growing bigger and bigger, and dial interfaces of the mobile devices are becoming too small. When users perform operations on the dial interfaces using only one hand, some keys on the dial interfaces are far away and out of a touch of the one hand, causing inconvenience to the users.

### BRIEF DESCRIPTION OF THE DRAWINGS

FIG. 1 is a block diagram of one embodiment of a mobile device including a dial interface management system.

FIG. 2 is a block diagram of one embodiment of function modules of the dial interface management system in FIG. 1.

FIG. 3 is a flowchart of one embodiment of a method for managing the dial interface of the mobile device.

FIG. 4 is a diagram of one embodiment of controlling the mobile device to operate in a right-hand mode.

FIG. 5 is a diagram of one embodiment of controlling the mobile device to operate in a left-hand mode.

FIG. 6 is a diagram of one embodiment of switching the right-hand mode from the left-hand mode or switching the left-hand mode from the right-hand mode.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

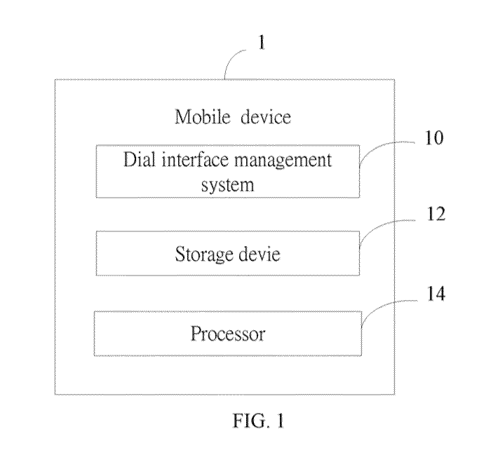

FIG. 1 is a block diagram of one embodiment of a mobile device 1 including a dial interface management system 10, a storage device 12, at least one processor 14. The mobile device 1 may be a cell phone, a tablet, a personal digital assistant (PDA), or other mobile device. The dial interface management system 10 is used to manage the dial interface of the mobile device 1.

In one embodiment, the storage device 12 (a non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

In one embodiment, the dial interface management system 10 includes a plurality of function modules which include computerized codes or instructions that can be stored in the storage device 12 and executed by the at least one processor 14 to provide a method for managing the dial interface of the mobile device 1.

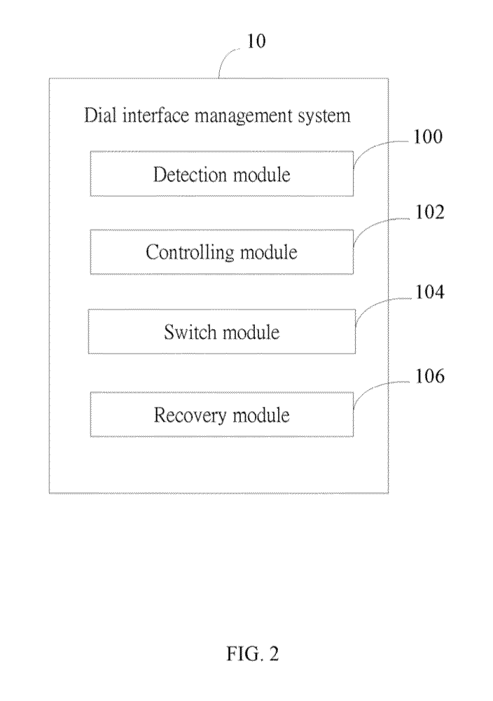

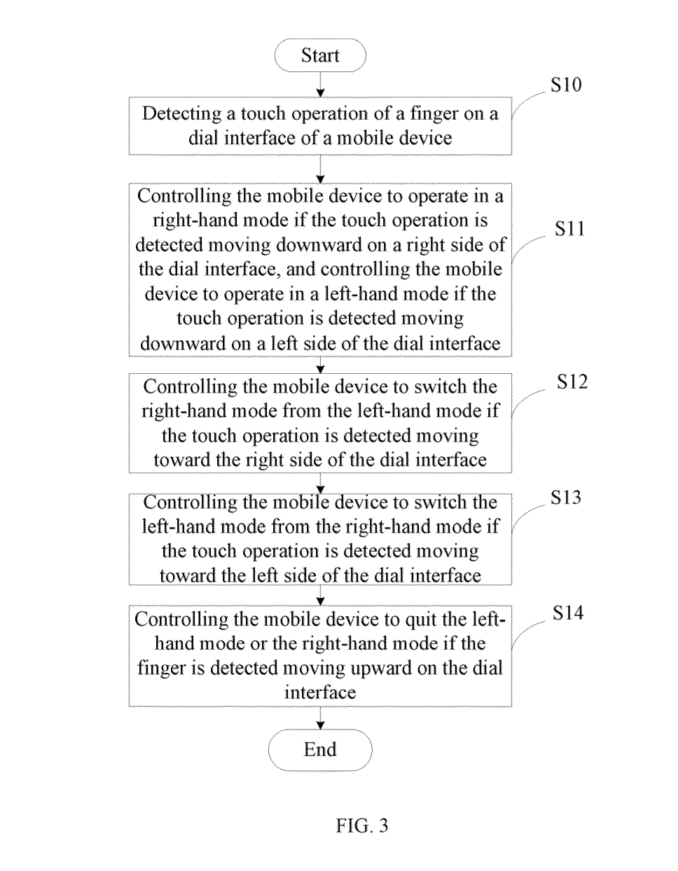

FIG. 2 is a block diagram of one embodiment of function modules of the dial interface management system 10 in FIG. 1. In the embodiment, the dial interface management system 10 includes a detection module 100, a controlling module 102, a switch module 104, and a recovery module 106. The modules may comprise computerized codes in the form of one or more programs that are stored in the storage device 12 and executed by the at least one processor 14 to provide functions for implementing the dial interface management system 10. The functions of the function modules are illustrated in FIG. 3 and described below.

FIG. 3 is a flowchart illustrating one embodiment of a method for managing the dial interface of the mobile device 1. Depending on the embodiment, additional steps may be added, others removed, and the ordering of the steps may be changed.

In step S10, the detection module 100 detects a touch operation of a finger on the dial interface of the mobile device 1.

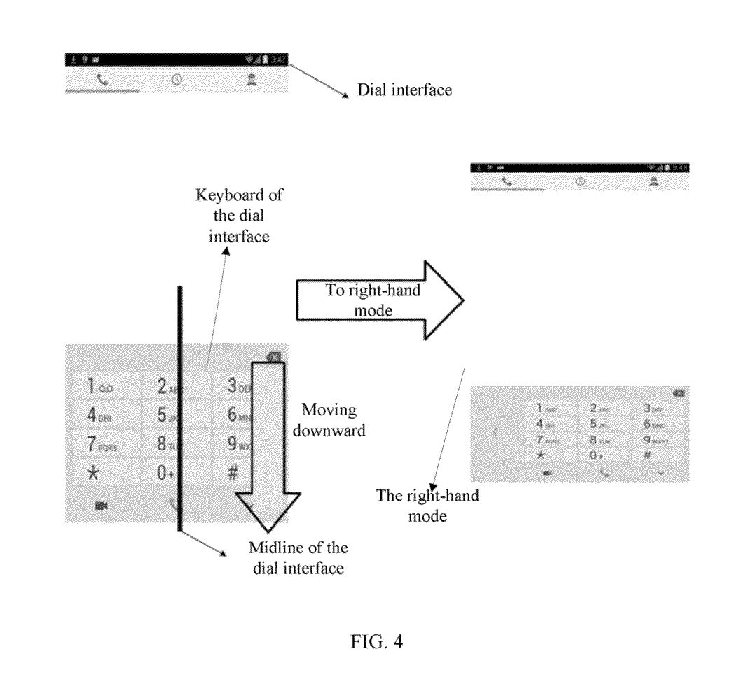

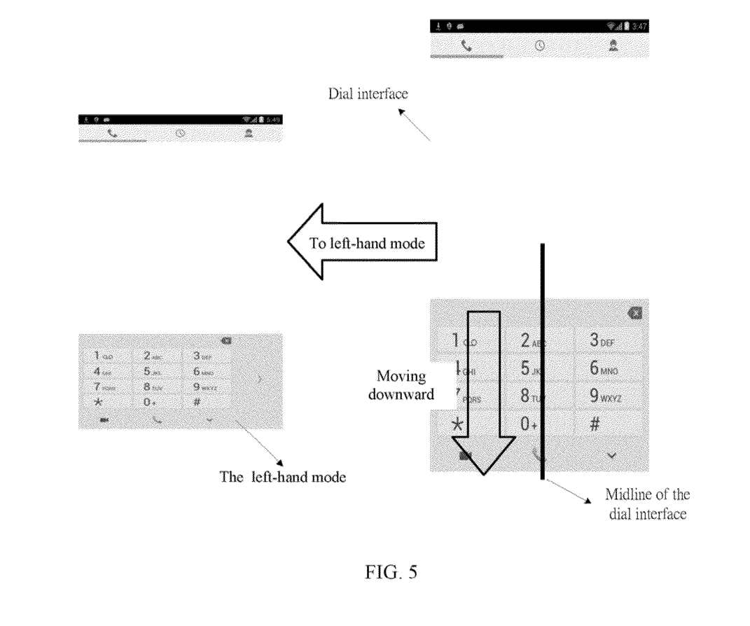

In step S11, the controlling module 102 controls the mobile device 1 to operate in a right-hand mode. In the right-hand mode, and as shown in FIG. 4, the right-hand mode displays the dial interface on a right side of a screen of the mobile device 1 if the touch operation is detected moving downward on the right side of the dial interface, and displays a keypad of the dial interface on a right side of the dial interface. The controlling module 102 further controls the mobile device 1 to operate in a left-hand mode. In the left-hand mode, and as shown in FIG. 5, the left-hand mode displays the dial interface on a left side of a screen of the mobile device 1 if the touch operation is detected moving downward on the left side of the dial interface, and displays a keypad of the dial interface on a left side of the dial interface. In the embodiment, the left side of the dial interface is defined as a left side of the midline of the dial interface, and the right side of the dial interface is defined as a right side of a midline of the dial interface.

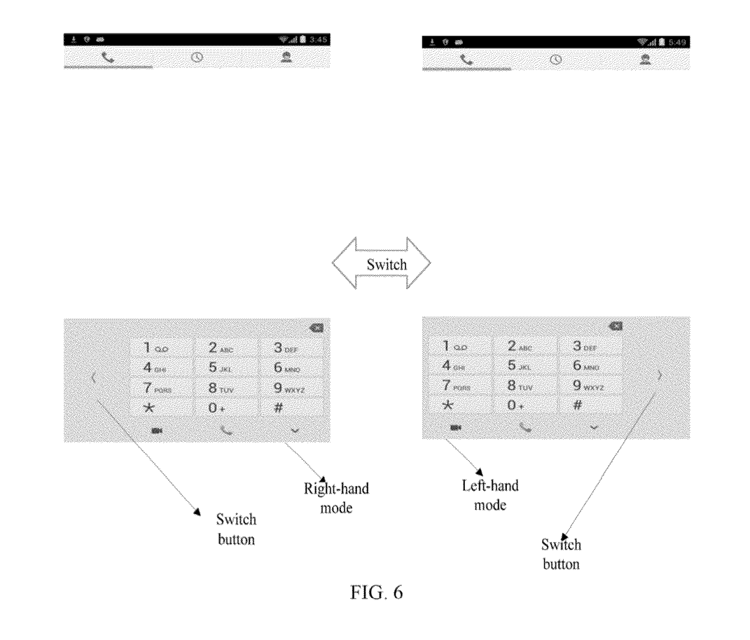

In step S12, the switch module 104 switches the right-hand mode of the mobile device 1 from the left-hand mode of the mobile device 1 if the touch operation is detected moving toward the right side of the dial interface. As shown in FIG. 6, the right-hand mode of the mobile device 1 is switched from the left-hand mode of the mobile device 1 if the touch operation is detected moving toward the right side of the midline of the dial interface.

In step S13, the switch module 104 switches to the left-hand mode from the right-hand mode if the touch operation is detected moving toward the right side of the dial interface. As shown in FIG. 6, the left-hand mode of the mobile device 1 is switched from the right-hand mode of the mobile device 1 if the touch operation is detected moving toward the left side of the midline of the dial interface.

In step S14, the recovery module 106 controls the mobile device 1 to quit the left-hand mode or the right-hand mode if the detection module 100 detects that the touch operation is moving upward on the dial interface.

In the embodiment, the screen of the mobile device 1 comprises a switch button (as shown in FIG. 6), and the mobile device 1 may be switched between the left-hand mode and the right-hand mode when the switch button is pressed.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile device, comprising:
at least one processor; and
a storage device storing a computer program including instructions that, which executed by the at least one processor, causes the at least one processor to:
detect a touch operation of a finger on a dial interface of the mobile device;
control the mobile device to operate in a right-hand mode if the touch operation is detected moving downward on a right side of the dial interface, wherein the right-hand mode displays the dial interface on the right side of a screen of the mobile device, and displays a keypad of the dial interface on the right side of the dial interface in the right-mode;
control the mobile device to operate in a left-hand mode if the touch operation is detected moving downward on a left side of the dial interface, wherein the left-hand mode displays the dial interface on the left side of a screen of the mobile device, and displays a keypad of the dial interface on the left side of the dial interface.

2. The mobile device as claimed in claim 1, wherein the left side of the dial interface is defined as a left side of a midline of the dial interface, and the right side of the dial interface is defined as a right side of the midline of the dial interface.

3. The mobile device as claimed in claim 1, wherein the computer program further causes the at least one processor to:
control the mobile device to switch the left-hand mode from the right-hand mode if the touch operation is detected moving toward the left side of the dial interface; and
control the mobile device to switch the right-hand mode from the left-hand mode if the touch operation is detected moving toward the right side of the dial interface.

4. The mobile device as claimed in claim 1, wherein the computer program further causes the at least one processor to:
control the mobile device to quit the left-hand mode or the right-hand mode if the touch operation is detected moving upward on the dial interface.

5. The mobile device as claimed in claim 1, wherein the screen of the mobile device displays a switch button, and the mobile device is switched between the left-hand mode and the right-hand mode when the switch button is pressed.

6. A method executable by a processor of a mobile device for managing a dial interface of the mobile device, the method comprising:
detecting a touch operation of a finger on a dial interface of the mobile device;
controlling the mobile device to operate in a right-hand mode if the touch operation is detected moving downward on a right side of the dial interface, wherein the right-hand mode displays the dial interface on the right side of a screen of the mobile device, and displays a keypad of the dial interface on the right side of the dial interface in the right-mode;
controlling the mobile device to operate in a left-hand mode if the touch operation is detected moving downward on a left side of the dial interface, wherein the left-hand mode displays the dial interface on the left side of a screen of the mobile device, and displays a keypad of the dial interface on the left side of the dial interface.

7. The method as claimed in claim 6, wherein the left side of the dial interface is defined as a left side of a midline of the dial interface, and the right side of the dial interface is defined as a right side of the midline of the dial interface.

8. The method as claimed in claim 6, further comprising:
controlling the mobile device to switch the left-hand mode from the right-hand mode if the touch operation is detected moving toward the left side of the dial interface; and
controlling the mobile device to switch the right-hand mode from the left-hand mode if the touch operation is detected moving toward the right side of the dial interface.

9. The method as claimed in claim 6, further comprising:
controlling the mobile device to quit the left-hand mode or the right-hand mode if the touch operation is detected moving upward on the dial interface.

10. The method as claimed in claim 6, wherein the screen of the mobile device displays a switch button, and the mobile device is switched between the left-hand mode and the right-hand mode when the switch button is pressed.

11. A non-transitory computer-readable storage medium having stored thereon instructions being executed by a processor of a mobile device, causes the processor to perform a method for managing a dial interface of the mobile device, the method comprising:
detecting a touch operation of a finger on a dial interface of the mobile device;
controlling the mobile device to operate in a right-hand mode if the touch operation is detected moving downward on a right side of the dial interface, wherein the right-hand mode displays the dial interface on the right side of a screen of the mobile device, and displays a keypad of the dial interface on the right side of the dial interface in the right-mode;
controlling the mobile device to operate in a left-hand mode if the touch operation is detected moving downward on a left side of the dial interface, wherein the left-hand mode displays the dial interface on the left side of a screen of the mobile device, and displays a keypad of the dial interface on the left side of the dial interface.

12. The storage medium as claimed in claim 11, wherein the left side of the dial interface is defined as a left side of a midline of the dial interface, and the right side of the dial interface is defined as a right side of the midline of the dial interface.

13. The storage medium as claimed in claim 11, wherein the method further comprises:
controlling the mobile device to switch the left-hand mode from the right-hand mode if the touch operation is detected moving toward the left side of the dial interface; and
controlling the mobile device to switch the right-hand mode from the left-hand mode if the touch operation is detected moving toward the right side of the dial interface.

14. The storage medium as claimed in claim 11, wherein the method further comprises:
controlling the mobile device to quit the left-hand mode or the right-hand mode if the touch operation is detected moving upward on the dial interface.

15. The storage medium as claimed in claim 11, wherein the screen of the mobile device displays a switch button, and the mobile device is switched between the left-hand mode and the right-hand mode when the switch button is pressed.
